(19) United States
(12) Patent Application Publication
(10) Pub. No.: US 2008/0210676 A1
(43) Pub. Date: Sep. 4, 2008

(54) Portable welder

(76) Inventors: Rod Lambirth, Kenna, NM (US); Brady Kane Adams, Pahrump, NV (US)

Correspondence Address: AMSTER, ROTHSTEIN & EBENSTEIN LLP, 90 PARK AVENUE, NEW YORK, NY, 10016, US

(21) Appl. No.: 12/070,963

(22) Filed: Feb. 22, 2008

Related U.S. Application Data
(63) Continuation-in-part of application No. 11/728,696, filed on Mar. 26, 2007.
(60) Provisional application No. 60/902,695, filed on Feb. 22, 2007.
(60) Provisional application No. 60/796,835, filed on May 1, 2006.

(51) Int. Cl. B23K 9/10

(52) U.S. Cl. 219/130.1

(57) ABSTRACT

A portable welder including a housing having a handle, a power supply contained within the housing, and welding wire stored within the housing that receives welding current from the power supply. An end portion of the welding wire extends from an opening in the housing so that the end portion of the welding wire can be placed in contact with a workpiece.

### RELATED APPLICATIONS

This application claims priority to U.S. Provisional Patent Application Ser. No. 60/902,695, filed Feb. 22, 2007, and is a continuation-in-part of U.S. patent application Ser. No. 11/728,696, filed Mar. 26, 2007, which claims priority to U.S. Provisional Patent Application Ser. No. 60/796,835, filed May 1, 2006.

### FIELD OF THE INVENTION

The present invention relates to welders, and in particular to self-contained portable welders having an internal power supply.

### BACKGROUND OF THE INVENTION

Arc welding is used to join two metal work pieces either by melting the metal work pieces directly or by melting a metal electrode between the metal work pieces using heat generated from an arc of high electricity formed between the work pieces and the metal electrode. The metal electrode is designed to conduct current generated by an arc welder to sustain the arc and to provide filler metal to form the weld.

There are numerous arc-welding devices known in the art, most of which include bulky and relatively heavy housing units that must be connected to a power source, such as a wall outlet or the battery of a vehicle. For example, U.S. Pat. No. 5,410,126 to Miller discloses a wire feed welder that is described as being “portable”. However, the welder of Miller requires an external source of power, which may either be utility power or a battery power source, such as a car battery. Thus, although the Miller welder can be relocated to and used at different work sites as long as an external power source is available, it is not portable in the sense that it does not allow the user to weld at various work sites without being tethered to a power source.

Accordingly, there is a need for a truly portable and self-contained welder that allows a user to relocate the welder from one work site to another without requiring an external power source to power the welder.

### SUMMARY OF THE INVENTION

A portable welder according to an exemplary embodiment of the present invention comprises: a housing having a handle; a power supply contained within the housing; and welding wire stored within the housing that receives welding current from the power supply, an end portion of the welding wire extending from an opening in the housing so that the end portion of the welding wire can be placed in contact with a workpiece.

In at least one embodiment, the portable welder further comprises a welding tip disposed on the housing, the end portion of the welding wire being in electrical contact with and extending through the welding tip.

In at least one embodiment, the power supply delivers welding current to the welding wire through the welding tip.

In at least one embodiment, the portable welder further comprises a rotatable welding wire spool contained with the housing that stores the welding wire, wherein rotation of the welding wire spool feeds the welding wire off of the welding wire spool and through the opening in the housing.

In at least one embodiment, the housing comprises a removable spool cover disposed over the welding wire spool.

In at least one embodiment, the portable welder further comprises a welding wire feed mechanism that feeds the welding wire from the welding wire spool through the opening in the housing.

In at least one embodiment, the welding wire feed mechanism comprises: a first roller; a second roller disposed adjacent to the first roller so as to form a nip between the first roller and the second roller, the welding wire being fed through the nip; and a motor that drives the first roller relative to the second roller to cause the welding wire to be pulled through the nip, the motor being powered by the power supply.

In at least one embodiment, the portable welder further comprises a spring mechanism that biases the second roller against the first roller.

In at least one embodiment, the portable welder further comprises a welding wire feed control system the controls the speed at which the welding wire is fed from the welding wire spool through the opening in the housing.

In at least one embodiment, the welding wire feed control system comprises a user-adjustable voltage regulator that regulates the voltage delivered to the motor from the power supply.

In at least one embodiment, the portable welder further comprises a welding control electrical circuit that controls a level of current delivered to the welding wire from the power supply.

In at least one embodiment, the welding control electrical circuit comprises a potentiometer that is adjustable by the user.

In at least one embodiment, wherein the potentiometer is adjustable by a switch located on the housing.

In at least one embodiment, the power supply comprises at least one battery.

In at least one embodiment, the at least one battery is a lithium iron phosphate battery.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is an elevation view of a portable welder according to an exemplary embodiment of the present invention;

FIG. 2 is a block diagram showing internal components of the portable welder of FIG. 1;

FIG. 3 is a diagram showing a current control circuit used in the portable welder of FIG. 1;

FIG. 4 is a plan view of a portable welder according to an exemplary embodiment of the present invention; and

FIG. 5 is a diagram view showing the internal components of the portable welder shown in FIG. 4.

### DETAILED DESCRIPTION OF PREFERRED EMBODIMENTS

Various exemplary embodiments of the present invention are directed to a portable welder that is lightweight enough for a user to easily transport the welder and perform welding jobs while still holding the welder either in hand or, for example, connected to a utility belt worn by the user. The welder according to the present invention is fully self-contained in that it includes an internal power supply which, in a preferred embodiment, includes one or more batteries. Thus, a user can simply remove the inventive portable welder from a storage shelf, charge the batteries in the welder, and walk to a work site with the welder to perform a welding operation.

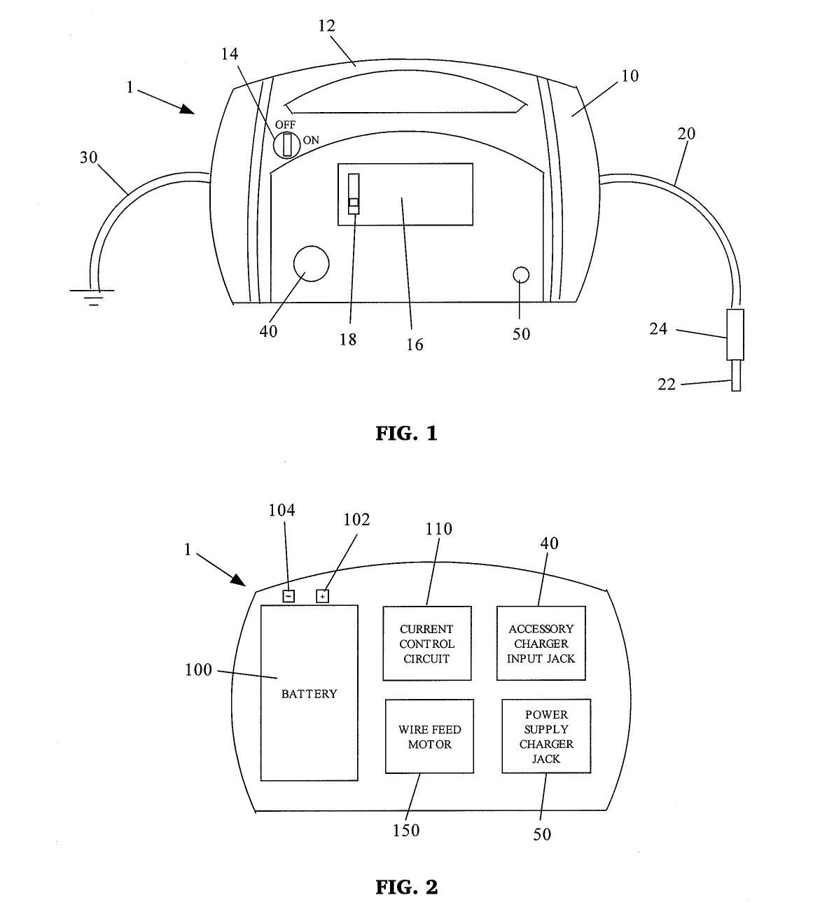

FIG. 1 is an elevation view of a portable welder, generally designated by reference number 1, according to an exemplary embodiment of the present invention. The portable welder 1 includes a housing 10 preferably made of a light-weight material, such as, for example, plastic. The housing 10 includes a handle portion 12 for ease of transport. The housing may also be equipped with attachments (not shown), such as hooks or straps, which allow the housing 10 to be hung from the user's utility belt or from an object nearby the work site while the portable welder 10 is in use.

The housing 10 includes a power on/off switch 14, and a control panel 16 that may include various other welding control switches and indicators. In a preferred embodiment, a current control switch 18 is provided in the control panel 16, the manipulation of which results in adjustment in the current delivered to a welding electrode, as discussed in further detail below.

A welding cable 20 extends from one side of the housing 10 and a ground cable 30 extends from the opposite side of the housing 10. A welding electrode 22 extends from a distal end of the welding cable 20. As is known in the art, current delivered to the electrode 22 creates an arc between the electrode 22 and a work piece, which in turn generates heat that melts the electrode onto the work piece.

The housing 10 may also include an accessory charger input jack 40 for insertion of an accessory, such as, for example, a flashlight, for charging from an internal power supply, as described in further detail below. In this regard, the housing 10 may include mounts (not shown) for storage of a variety of accessories. The housing 10 also includes a power supply charger jack 50 that receives a plug from a charger (not shown) to charge the internal power supply of the portable welder 1.

FIG. 2 is a block diagram showing the internal components of the portable welder 1. The portable welder 1 includes a battery 100 which supplies power to the portable welder 1. The battery is preferably a Sealed-Lead Acid (SLA) battery, which may either be an Absorbed Glass Mat (AGM) SLA battery or a Gel Cell SLA battery. However, an AGM-SLA battery is preferred for consistency in operation. Although only one battery 100 is shown in FIG. 2, it should be appreciated that any number and combination of different types of batteries may be used to provide the necessary welding power. The battery 100 includes a positive lead 102 and negative lead 104. The welding cable 20 is electrically connected to the positive lead 102, and the ground cable 30 is electrically connected to the negative lead 104. As is known in the art, connection of a welding cable to a positive lead of a battery results in higher temperature welds and therefore deeper penetration. Alternatively, the welding cable 20 may be electrically connected to the negative lead 104 and the ground cable 30 may be connected to the positive lead 102.

As the heat of the arc between the electrode 22 and a work piece depends on the current delivered to the electrode during the welding operation, it is important to maintain a constant current in the electrode, even as the voltage varies. Maintaining a stable welding temperature results in a more consistent weld. Thus, the portable welder 1 also includes a current control circuit 110 that maintains the current output from the battery 100 at a user-controlled level selected using the current control switch 18.

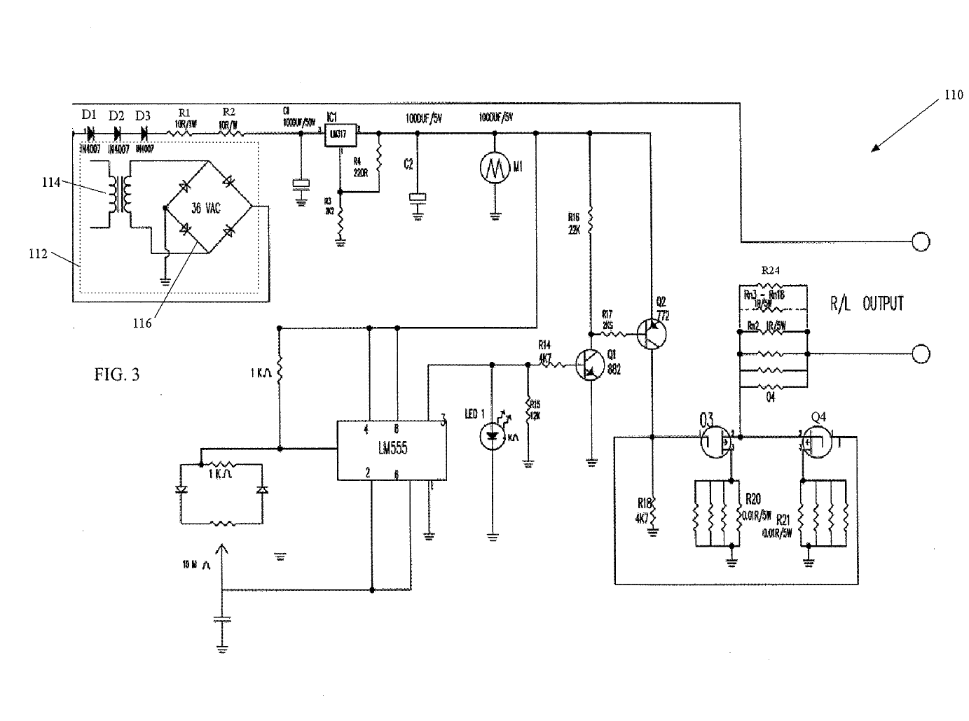

FIG. 3 is a diagram of the current control circuit 110 according to an exemplary embodiment of the present invention. The current control circuit 110 includes a charging circuit, generally designated by reference number 112. The charging circuit 112 includes a 115 VAC to 36 VAC step down transformer 114. A 4-diode bridge rectifier 116 converts the AC voltage output from the transformer 114 to DC voltage.

The current control circuit 110 further includes three diodes D1-D3 in series that reduce the DC voltage slightly. Two resistors R1 and R2 in conjunction with two capacitors C1 and C2 form a voltage filter for a line voltage regulator LM317 which outputs a constant voltage. An LM555 oscillator generates a variable duty-cycle square wave signal. The signal is biased to ground through the resistor R15 and boosted through transistors Q1 and Q2. The boosted signal is then used to drive two high current output drivers Q3 and Q4 to generate an R/L output. The R/L output is rapidly switched between being grounded and open for the length of time determined by a 10M OHM potentiometer in the LM555 oscillator, adjusted by the user through the current control switch 18. Driver resistor banks R20 and R21 on the output drivers Q3 and Q4 and output resistor bank R24 on the R/L output equalize the load on the two drivers Q3 and Q4 and reduce the maximum current draw.

The portable welder 1 may be a stick welder, in which case the welding electrode 22 is a stick electrode. Alternatively, the welding electrode 22 may be a wire electrode that extends through the welding cable 20. In the case of a wire electrode, the portable welder 1 may include a wire feed motor 150 that drives the wire electrode off of a spool as the electrode is consumed. The wire feed motor 150 may be disposed within the housing 10 or within a welding gun 24 disposed at the distal end portion of the welding cable 20.

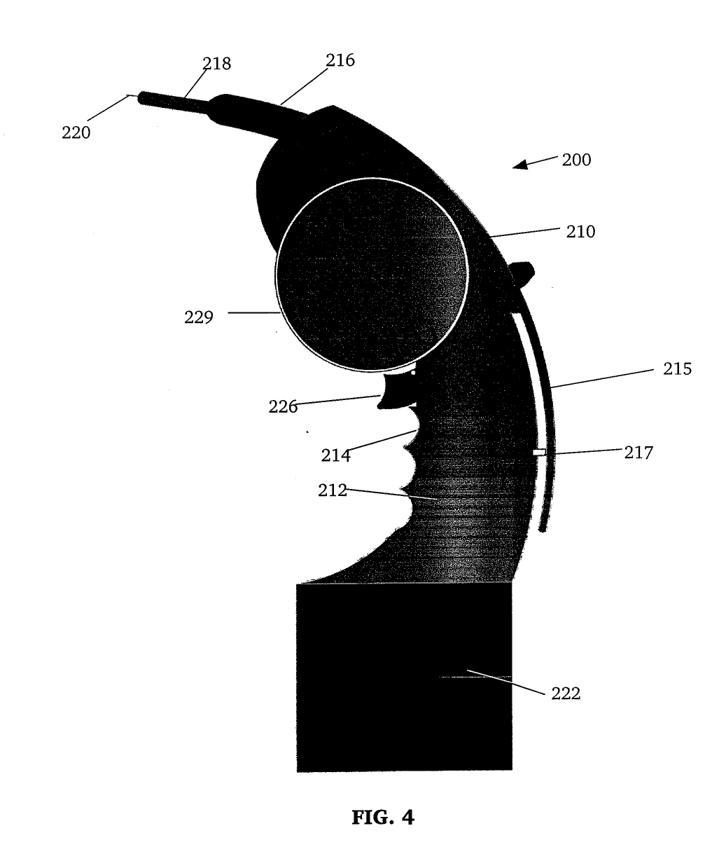

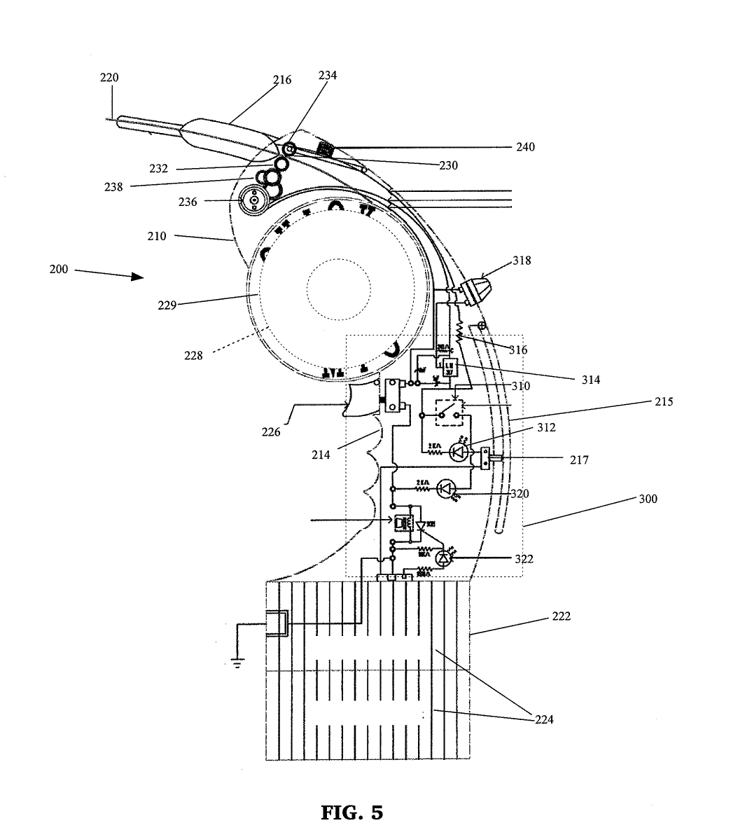

FIG. 4 is a plan view of a portable welder, generally designated by reference number 200, according to another exemplary embodiment of the present invention. The portable welder 200 is compact in size and relatively light in weight, so that it may be held in a user's hand during transport as well as in use. The portable welder 200 includes a housing 210. The housing 210 preferably has a gun-like configuration, so that the housing 210 can be easily held in a user's hand. In this regard, the housing 210 may include a handle portion 212 having one or more finger-grip portions 214. A barrel 216 may be attached to the distal end portion of the housing 210, with a welding tip 218 extending from the barrel 216. As explained in more detail below, welding wire 220 extends from inside the housing 210 through the barrel 216 and the welding tip 218 so that it may be placed in contact with a work piece. A switch 226 for extending additional welding wire 220 through the welding tip 218 as the welding wire 220 is melted away during a welding operation may be disposed at the handle portion 212. The switch 226 is preferably a trigger switch, so that a user can easily extend the welding wire 220 while holding the portable welder 200 in one hand.

The portable welder 200 also includes a safety grip mechanism 215, which is naturally compressed by a user during use and which also results in depression of a safety switch 217 located on the housing 210 below the safety grip mechanism 215. As explained in further detail below, depression of the safety switch 217 activates the portable welder 200 for use. Thus, the portable welder 200 can not be accidentally triggered when it is not held properly by a user.

A power supply 222 may be disposed within the housing 210. The power supply 222 may include one or more batteries 224, and the batteries 224 are preferably lithium iron phosphate (LFP) batteries.

FIG. 2 is a diagram view showing the internal components of the portable welder 200. A welding wire spool 228 is mounted for rotation within the housing 210. The welding wire 220 is wrapped around the welding wire spool 228 except for a distal portion of the welding wire 200 that extends from the welding wire spool 228 through the barrel 216 and the welding tip 218. Once empty, the welding wire spool 228 may be accessed through an opening in the housing 210 for replacement with a new welding wire spool 228. In this regard, the housing 210 may include a latch 229 that may be removed for access to the welding wire spool 228. The latch 229 may be hinged to the housing 210 or completely removable from the housing 210.

As the welding wire 220 is melted away during a soldering operation, more of the welding wire 220 may be fed from the welding wire spool 228 through the welding tip 218 and into contact with a work piece (not shown). In this regard, the welding wire 220 may be pulled through a nip 230 formed between a first roller 232 and a second roller 234. The first and second rollers 232, 234 are preferably knurled rollers for better grip of the welding wire 220, and may be made of any suitable material, such as, for example, metal, plastic or rubber. The first roller 232 may be driven by a motor 236 that is powered by the power supply 222. The motor 236 may be, for example, a permanent magnet micro motor that drives the roller 232 through a compact gear reduction drive train 238.

The second roller 234 is preferably biased against the first roller 232 so that the welding wire 220 is more firmly held within the nip 230. In this regard, a spring lever 240 may be mounted within the housing 210 and in contact with the second roller 234 to bias the second roller 234 against the first roller 232.

A welding control electrical circuit, generally designated by reference number 300, is also contained within the housing 210. In the exemplary embodiment shown in FIG. 2, the welding control electrical circuit 300 includes the hi-energy density LFP battery 224 located at the base of the portable welder 200. The negative side of the battery 224 may be connected via a cable (not shown) through an opening in the housing 210 to a work piece-grounding strap. The positive side of the battery 224 is connected to a 50 amp momentary normally open switch that forms the safety switch 217. As hand pressure is applied, the safety grip mechanism 215 compresses the safety switch 217, which results in application of current to a 50 amp auto reset safety breaker 310. A first light emitting diode 312 is exposed through the housing 210 and is configured to signal when it has overloaded and tripped the safety breaker 310. Current from the safety breaker 310 is then applied to the load side of a bank of push-pull output transistors (not shown) which are preferably heat-sunk to a metallic portion of the housing 210. The output stage of the output transistors apply current to a bank of carbon-pile load resistors 316, thus evenly distributing the current between the output transistors and further stabilizing and regulating the maximum output of the welder.

The output of the load resistors is attached to the welding tip 218 in direct contact with and thus delivering a metered energy to the welding wire 220. An adjustable pulse width square wave signal generator circuit (not shown) provides a low voltage trigger signal to the output transistors. A potentiometer 318 is exposed through the housing 210 for user-adjustment of the pulse width and subsequently the current output. The safety switch 217 also energizes the signal generator circuit. A second light emitting diode 320 may be exposed through the housing 210 and in the circuit after the safety switch 217 to confirm when the circuit 300 is energized.

A thermocouple temperature probe may be mounted on the battery 224 and provides a reading to the pulse width signal generator circuit. The signal generator circuit may then regulate the duty cycle of the welder 200 using the input from the probe, and therefore reduce the output current based upon the battery temperature. A high battery temperature may also activate a third light emitting diode 322 exposed through the housing 210.

The switch 226 is preferably a low current normally open on-off switch. Upon application of the switch 226, a true-voltage regulator circuit 314 will be energized, thereby providing a stabilized voltage to a pulse-width motor speed control circuit comprised of the signal generator circuit and a low-current output transistor (not shown) delivering a metered signal to a the motor 236. The voltage regulator circuit may be adjusted by the potentiometer 318.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A portable welder comprising:
a housing having a handle;
a power supply contained within the housing; and
welding wire stored within the housing that receives welding current from the power supply, an end portion of the welding wire extending from an opening in the housing so that the end portion of the welding wire can be placed in contact with a workpiece.

2. The portable welder of claim 1, further comprising a welding tip disposed on the housing, the end portion of the welding wire being in electrical contact with and extending through the welding tip.

3. The portable welder of claim 2, wherein the power supply delivers welding current to the welding wire through the welding tip.

4. The portable welder of claim 1, further comprising a rotatable welding wire spool contained with the housing that stores the welding wire, wherein rotation of the welding wire spool feeds the welding wire off of the welding wire spool and through the opening in the housing.

5. The portable welder of claim 4, wherein the housing comprises a removable spool cover disposed over the welding wire spool.

6. The portable welder of claim 4, further comprising a welding wire feed mechanism that feeds the welding wire from the welding wire spool through the opening in the housing.

7. The portable welder of claim 6, wherein the welding wire feed mechanism comprises:
a first roller;
a second roller disposed adjacent to the first roller so as to form a nip between the first roller and the second roller, the welding wire being fed through the nip; and
a motor that drives the first roller relative to the second roller to cause the welding wire to be pulled through the nip, the motor being powered by the power supply.

8. The portable welder of claim 7, further comprising a spring mechanism that biases the second roller against the first roller.

9. The portable welder of claim 7, further comprising a welding wire feed control system the controls the speed at which the welding wire is fed from the welding wire spool through the opening in the housing.

10. The portable welder of claim 9, wherein the welding wire feed control system comprises a user-adjustable voltage regulator that regulates the voltage delivered to the motor from the power supply.

11. The portable welder of claim 1, further comprising a welding control electrical circuit that controls a level of current delivered to the welding wire from the power supply.

12. The portable welder of claim 11, wherein the welding control electrical circuit comprises a potentiometer that is adjustable by the user.

13. The portable welder of claim 11, wherein the potentiometer is adjustable by a switch located on the housing.

14. The portable welder of claim 1, wherein the power supply comprises at least one battery.

15. The portable welder of claim 15, wherein the at least one battery is a lithium iron phosphate battery.
